(19) United States
(12) Patent Application Publication
(10) Pub. No.: US 2025/0247603 A1
(43) Pub. Date: Jul. 31, 2025

(54) ELECTRONIC DEVICE, CONTROL METHOD OF ELECTRONIC DEVICE, AND NON-TRANSITORY COMPUTER READABLE MEDIUM

(71) Applicant: CANON KABUSHIKI KAISHA, Tokyo (JP)

(72) Inventor: TORU KOHNO, Kanagawa (JP)

(21) Appl. No.: 19/018,340

(22) Filed: Jan. 13, 2025

(30) Foreign Application Priority Data
Jan. 30, 2024 (JP) 2024-011967

(51) Int. Cl. H04N 23/62; H04N 23/56; H04N 23/61; H04N 23/63

(52) U.S. Cl. CPC H04N 23/62; H04N 23/56; H04N 23/635; H04N 23/61

(57) ABSTRACT

An electronic device includes a processor; and a memory storing a program which, when executed by the processor, causes the electronic device to: perform estimating processing to estimate, based on eyeball information, which is information related to an eye of a user viewing a picked-up image, a visual-recognition range of the user in the picked-up image; perform acquiring processing to acquire a region including an object from the picked-up image; and perform control processing to perform control such that at least either one of an irradiation range and an irradiation direction of an illuminating unit configured to illuminate a photographing target is set based on the visual-recognition range estimated in the estimating processing and the region including the object acquired in the acquiring processing.

### BACKGROUND OF THE INVENTION

### Field of the Invention

The present invention relates to an electronic device, a control method of the electronic device, and a non-transitory computer readable medium.

### Description of the Related Art

A recent flash device can easily perform photographing within an appropriate irradiation range under a basic photographing condition by setting the irradiation range on the basis of lens-zoom information of an imaging device. In addition, the flash device is capable of controlling the irradiation range on the basis not only of the lens-zoom information but also of additional information such as electronic zoom.

Japanese Patent Application Laid-Open No. 2004-191595 discloses controlling, in an optical zoom region, an irradiation angle of a flash device in conjunction with focal-distance information, while controlling, in an electronic zoom region, the irradiation angle of the flash device in conjunction with field-angle variable power rate information.

However, an irradiation range of a flash device determined on the basis of information related to an optical zoom and an electronic zoom is not necessarily a range intended by a user.

### SUMMARY OF THE INVENTION

The present invention provides an electronic device which can perform photographing by efficiently irradiating an irradiation range intended by a user.

An electronic device of the present invention includes a processor; and a memory storing a program which, when executed by the processor, causes the electronic device to: perform estimating processing to estimate, based on eyeball information, which is information related to an eye of a user viewing a picked-up image, a visual-recognition range of the user in the picked-up image; perform acquiring processing to acquire a region including an object from the picked-up image; and perform control processing to perform control such that at least either one of an irradiation range and an irradiation direction of an illuminating unit configured to illuminate a photographing target is set based on the visual-recognition range estimated in the estimating processing and the region including the object acquired in the acquiring processing.

Further features of the present invention will become apparent from the following description of exemplary embodiments with reference to the attached drawings.

### BRIEF DESCRIPTION OF THE DRAWINGS

FIGS. 1A and 1B are appearance views of an imaging device according to an Embodiment 1;

FIG. 2 is a block diagram illustrating a configuration example of the imaging device;

FIG. 3A is a flowchart for explaining irradiation processing according to the Embodiment 1;

FIG. 3B is a flowchart for explaining the irradiation processing according to the Embodiment 1;

FIGS. 4A to 4D are diagrams for explaining a relation between eyeball information and an irradiation range;

FIGS. 5A and 5B are diagrams for explaining a change in the irradiation range and an irradiation direction;

FIG. 6 is an appearance view of a wearable device according to an Embodiment 2;

FIG. 7 is a block diagram illustrating a configuration example of a wearable device;

FIG. 8A is a flowchart for explaining irradiation processing according to the Embodiment 2; and

FIG. 8B is a flowchart for explaining the irradiation processing according to the Embodiment 2.

### DESCRIPTION OF THE EMBODIMENTS

### Embodiment 1

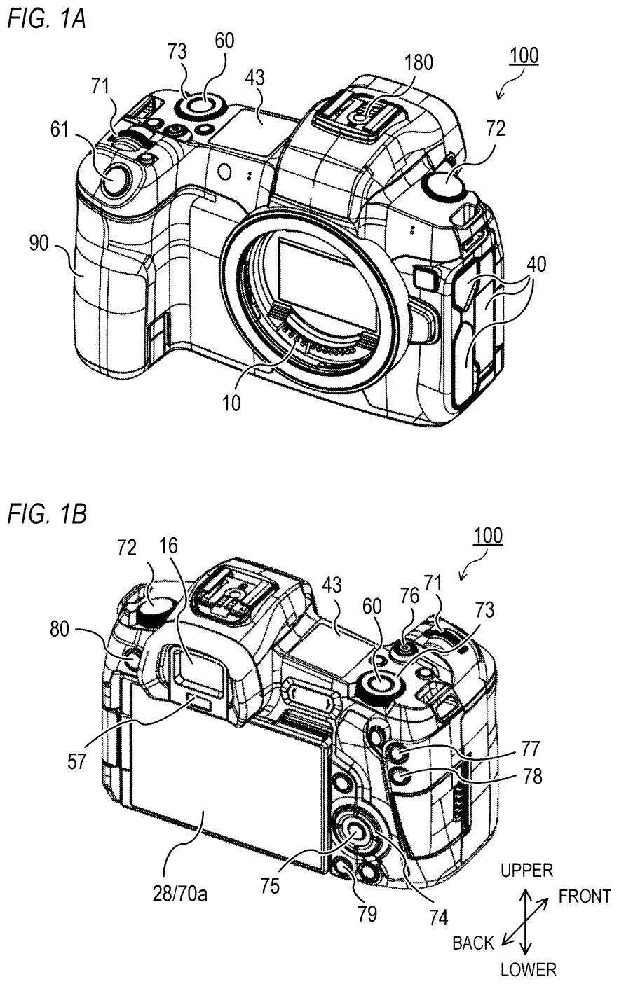

Hereinafter, with reference to the drawings, embodiments of the present invention will be explained. FIGS. 1A and 1B are appearance views of an imaging device 100 as an example of an electronic device to which the present invention can be applied. FIG. 1A is a perspective view of the imaging device 100 when viewed from a front surface. FIG. 1B is a perspective view when the imaging device 100 is viewed from a rear surface.

The imaging device 100 has a shutter button 61, a power switch 72, a mode-switching switch 60, a main electronic dial 71, a sub electronic dial 73, a movie button 76, and an extra-finder display portion 43 on an upper surface. The shutter button 61 is an operation member for giving a photographing-preparation instruction or a photographing instruction. The power switch 72 is an operation member for switching on and off of a power supply of the imaging device 100. The mode-switching switch 60 is an operation member for switching various modes. The main electronic dial 71 is a rotary operation member for changing a set value such as a shutter speed, a diaphragm and the like. The sub electronic dial 73 is a rotary operation member for performing movement of a selection frame (cursor), image feeding and the like. The movie button 76 is an operation member for giving instructions to start or stop video photographing (recording). The extra-finder display portion 43 displays various set values such as the shutter speed, the diaphragm and the like.

The imaging device 100 has a display portion 28, a touch panel 70a, a direction key 74, a SET button 75, an AE lock button 77, an enlargement button 78, a reproducing button 79, a menu button 80, an eyepiece portion 16, and an eyepiece-detection portion 57 on the rear surface.

The display portion 28 displays images and various types of information. The touch panel 70a is an operation member for detecting a touch operation on a display surface (touch operation surface) of the display portion 28. The direction key 74 is an operation member constituted by a key (4-directional key) that can be pressed down up, down, right, and left. Processing according to a pressed-down position on the direction key 74 is possible. The SET button 75 is an operation member which is pressed down for mainly determining a selection item. The AE lock button 77 is an operation member which is pressed down for fixing an exposure state in a photographing-standby state. The enlargement button 78 is an operation member for switching between on and off of an enlargement mode in a live-view display (LV display) of a photographing mode. When the enlargement mode is on, a live-view image (LV image) is enlarged or reduced by an operation of the main electronic dial 71. In addition, the enlargement button 78 is used for enlarging a reproduced image in a reproducing mode or for increasing an enlargement rate. The reproducing button 79 is an operation member for switching between the photographing mode and the reproducing mode.

The menu button 80 is an operation member which is pressed down for displaying a menu screen capable of various settings on the display portion 28. A user can intuitively make various settings by using the direction key 74 and the SET button 75 on the menu screen displayed on the display portion 28. The eyepiece portion 16 is an eyepiece portion of an eyepiece finder (peeping-type finder). The user can visually recognize an image displayed on an EVF (Electronic View Finder) 29 inside the imaging device 100 through the eyepiece portion 16. The eyepiece-detection portion 57 is a sensor for detecting whether or not the user is positioning the eye on the eyepiece portion 16 of the eyepiece finder.

In addition, the imaging device 100 has a grip portion 90, a terminal cover 40, a communication terminal 10, a communication terminal 180 and the like. The grip portion 90 is a holding portion formed into a shape that can be gripped by the right hand, when the user holds the imaging device 100. In a state where the grip portion 90 is gripped by the little finger, the third finger, and the middle finger of the right hand, and the imaging device 100 is held, the shutter button 61 and the main electronic dial 71 are disposed at positions that can be operated by the forefinger of the right hand. In addition, in the similar state, at a position that can be operated by the thumb of the right hand, the sub electronic dial 73 is disposed. The terminal cover 40 protects a communication terminal 181 (connector) such as a connection cable for connecting the imaging device 100 to external equipment (external devices). The communication terminal 10 is a terminal for communicating with a lens unit 150 which can be detachably attached to the imaging device 100. The communication terminal 180 is a terminal for performing communication with a flash device 300 that can be detachably attached to the imaging device 100.

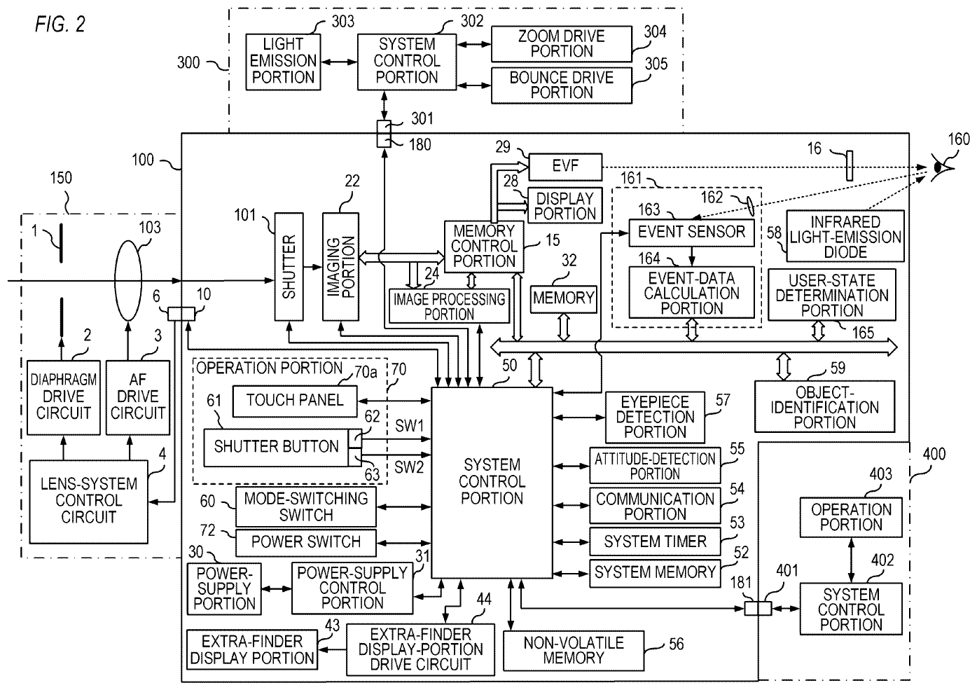

FIG. 2 is a block diagram illustrating a configuration example of the imaging device 100 as electronic equipment. The lens unit 150 is a lens unit on which a replaceable photographing lens is mounted. A lens 103 is usually constituted by a plurality of lenses, but FIG. 2 illustrates one piece of lens for simplification.

The communication terminal 6 is a communication terminal by which the lens unit 150 performs communication with the imaging device 100 side, and the communication terminal 10 is a communication terminal by which the imaging device 100 performs communication with the lens unit 150 side. The lens unit 150 communicates with a system control portion 50 through these communication terminals 6, 10. The lens unit 150 controls a diaphragm 1 through a diaphragm drive circuit 2 by a lens-system control circuit 4 inside. In addition, the lens unit 150 focuses by the lens-system control circuit 4 by displacing the lens 103 through an AF drive circuit 3.

The shutter 101 is a focal-plane shutter capable of freely controlling exposure time of an imaging portion 22 by control of the system control portion 50, for example.

The extra-finder display portion 43 displays various set values of the imaging device 100 including a shutter speed and a diaphragm through an extra-finder display-portion drive circuit 44.

The imaging portion 22 is an image pickup element (image pickup sensor) constituted by a CCD and a CMOS element which convert an optical image to an electric signal. In the imaging portion 22, an A/D converter (not shown) is provided, and the A/D converter is used for converting an analog signal output from the imaging portion 22 to a digital signal. Imaging by the imaging portion 22 is performed in synchronization with a horizontal synchronization signal and a vertical-line synchronization signal output from a timing generator (not shown). The imaging portion 22 outputs image data for 1 frame as a frame data in a period of the vertical-line synchronization signal. An event sensor 163 is an event-based vision sensor (asynchronous event-based type sensor), while the imaging portion 22 is a synchronous frame-based type sensor.

An image processing portion 24 executes predetermined processing (pixel interpolation, resizing processing such as contraction, color-conversion processing and the like) to data from the imaging portion 22 (A/D converter) or data from a memory control portion 15. In addition, the image processing portion 24 executes predetermined arithmetic processing by using the picked-up image data. The system control portion 50 executes exposure control and distance-measurement control on the basis of an arithmetic result acquired by the image processing portion 24. As a result, TTL (Through The Lens) system AF (Auto Focus) processing and AE (Automatic Exposure) processing are executed. The image processing portion 24 further executes predetermined arithmetic processing by using the picked-up image data and executes TTL system AWB (Auto White Balance) processing on the basis of the acquired arithmetic results. In addition, the image processing portion 24 can execute picture-style processing which converts a picked-up image (image data) to a color image or a monochromic image.

The memory control portion 15 controls data transmission/reception among the imaging portion 22, the image processing portion 24, and a memory 32. Output data from the imaging portion 22 is written in the memory 32 through the image processing portion 24 and the memory control portion 15 or through the memory control portion 15 without through the image processing portion 24. The memory 32 stores image data acquired by the imaging portion 22 and image data to be displayed on the display portion 28, the EVF 29. In addition, the memory 32 also serves as a memory (video memory) for image display. The image data for display written in the memory 32 is displayed on the display portion 28 and the EVF 29 through the memory control portion 15.

The display portion 28 and the EVF 29 performs display corresponding to a signal from the memory control portion 15 on a display such as an LCD, an organic EL or the like. The image data accumulated in the memory 32 is sequentially transferred and displayed on the display portion 28 or the EVF 29, whereby the picked-up image can be through-displayed. The through-display is the same as so-called live-view display in a general digital camera, and in the through-display, a picked-up image is displayed substantially with no delay. The user can visually recognize an actual space indirectly by visually recognizing a through-displayed image.

A non-volatile memory 56 is an electrically erasable/recordable memory and is a Flash-ROM or the like, for example. The non-volatile memory 56 stores constants, programs and the like for operations of the system control portion 50. The program referred to here means a program for executing processing of various flowcharts, which will be described later.

The system control portion 50 is a control portion constituted by at least one processor or circuit and controls the entire imaging device 100. The system control portion 50 realizes the various processing by executing the program recorded in the non-volatile memory 56. A system memory 52 is a RAM, for example, and the system control portion 50 expands constants, variables, and programs read out of the non- volatile memory 56 and the like for operation of the system control portion 50 to the system memory 52. In addition, the system control portion 50 executes display control by controlling the memory 32, the display portion 28, the EVF 29 and the like.

A system timer 53 is a clocking portion which clocks time used for various controls and time of an incorporated clock.

An operation portion 70 is a various-operation member as an input portion which accepts an operation from a user (user operation) for instructing various operations to the system control portion 50. The operation portion 70 includes a shutter button 61, a touch panel 70a, for example. In addition, the operation portion 70 includes the main electronic dial 71, the sub electronic dial 73, the direction key 74, the SET button 75, the AE lock button 77, the enlargement button 78, the reproducing button 79, the menu button 80.

The shutter button 61 includes a first shutter switch 62 and a second shutter switch 64. The first shutter switch 62 is turned on by so-called half-pressing (instruction for photographing preparation) in the middle of the operation of the shutter button 61 and generates a first shutter-switch signal SW1. When the first shutter-switch signal SW1 is generated, the system control portion 50 starts the photographing preparation operation such as AF (Auto Focus) processing, AE (Automatic Exposure) processing, AWB (Auto White Balance) processing, EF (Pre-Flash) processing and the like.

The system control portion 50 calculates and sets an appropriate diaphragm value, a shutter speed, ISO sensitivity at photographing on the basis of a difference between an exposure amount calculated on the basis of a diaphragm value, the shutter speed, and the ISO sensitivity in the setting and an adequate exposure amount set in advance in the AE processing. The second shutter switch 63 is turned on by operation completion of the shutter button 61, so-called full-pressing (photographing instruction) and generates a second shutter-switch signal SW2. The system control portion 50 starts an operation of a series of photographing processing from signal reading from the imaging portion 22 until writing of a picked-up image, when the second shutter-switch signal SW2 is generated.

The touch panel 70a and the display portion 28 can be integrally constituted. For example, the touch panel 70a is constituted so that light transmittance does not prevent display of the display portion 28 and is mounted on an upper layer of a display surface of the display portion 28. And an input coordinate in the touch panel 70a and a display coordinate on the display screen of the display portion 28 are associated with each other. As a result, a graphical user interface (GUI) as if the user can directly operate a screen displayed on the display portion 28 can be provided.

The mode-switching switch 60 switches the operation mode to any one of a still-image photographing mode, a video photographing mode and the like. The still-image photographing mode includes an auto-photographing mode, an auto scene-discrimination mode, a manual mode, a diaphragm-priority mode (Av mode), a shutter-speed priority mode (Tv mode), and a program AE mode (P mode), for example. In addition, the still-image photographing mode includes various scene modes to become photographing setting for each photographing scene and a custom mode. The user can directly switch the operation mode to any one of these modes by the mode-switching switch 60. In addition, the operation mode may be switched when the user selects any one of the plurality of displayed modes by using another operation member after switching to a list screen of the photographing modes by the mode-switching switch 60 once. Similarly, the video photographing mode may include a plurality of modes.

A power-supply control portion 31 includes a battery detection circuit, a DC-DC converter, a switch circuit for switching a block to be electrically conducted and the like and detects presence/absence of attachment of the battery, a type of the battery, and a battery residual amount. In addition, the power-supply control portion 31 controls the DC-DC converter on the basis of the detection result and an instruction of the system control portion 50 and supplies a voltage to be used to each part for a predetermined period. A power-supply portion 30 is a primary battery such as an alkaline battery, a lithium battery and the like, a secondary battery such as a NiCd battery, a NiMH battery, a lithium-ion battery and the like, an AC adaptor and the like.

A communication portion 54 transmits/receives various types of data such as an image signal, a sound signal and the like with external equipment connected wirelessly or by a wired cable. The communication portion 54 is connectable also to a wireless LAN (Local Area Network) and the Internet. In addition, the communication portion 54 can communicate with the external equipment also by the Bluetooth (registered trademark) and the Bluetooth Low Energy. The communication portion 54 can transmit an image (including an LV image) picked up by the imaging portion 22 and can receive image data and other various types of information from the external equipment.

An attitude-detection portion 55 detects an attitude of the imaging device 100 with respect to a gravity direction. As the attitude-detection portion 55, an acceleration sensor, a gyro sensor or the like can be used. By means of the attitude-detection portion 55, movement of the imaging device 100 (panning, tilting, rolling, still or not and the like) can be detected.

An eyepiece-detection portion 57 is an eyepiece detection sensor which detects approach (approach to the eye) and separation (separation from the eye) of an object (eye) 160 to an eyepiece portion 16 of an eyepiece finder. The system control portion 50 switches display/non-display of the display portion 28 and the EVF 29 in accordance with a state detected by the eyepiece-detection portion 57.

A object-identification portion 59 analyzes image data acquired by the imaging portion 22 and identifies an object to be a photographing target. Specifically, the object-identification portion 59 identifies a type of the object. The object-identification portion 59 can specify a size of the object in the image and a position of the object in the image. The object-identification portion 59 can identify the object by using a convolutional neural network or the like used in general for image recognition, for example.

An eyeball detection unit 161 includes an eyeball detection lens 162, an event sensor 163, and an event-data calculation portion 164. The eyeball detection unit 161 can detect information related to an eye 160 of the user looking into the finder (hereinafter, described as eyeball information). Infrared light emitted from an infrared light-emission diode 58 is reflected by the user's eye 160, and the infrared reflection light passes through the eyeball detection lens 162 and forms an image on an image pickup surface of the event sensor 163.

The event sensor 163 is an event-based vision sensor that detects a luminance change of light incident to each pixel and outputs information on a pixel with the luminance change asynchronously with other pixels. The data output from the event sensor 163 includes a position coordinate of the pixel at which the luminance change (event) occurred, a polarity (positive/negative) of the luminance change, timing information corresponding to event occurrence time, for example. The data will be described as event data in the following.

The event sensor 163 has redundancy of output information reduced as compared with a synchronous-type frame-based type sensor such as the imaging portion 22 and has characteristics such as a high-speed operation, a high dynamic range, and low electric power. On the other hand, since event data (information on the pixel with the luminance change) is output asynchronously with the other pixels, processing for determining a relation between event data is executed. In order to determine the relation between the event data, event data output from the event sensor 163 in a predetermined time is accumulated, and various types of arithmetic processing are executed for the result.

The event-data calculation portion 164 is a calculation portion for acquiring (detecting) eyeball information on the basis of the event data asynchronously output continuously from the event sensor 163. For example, the event-data calculation portion 164 accumulates event data generated in a predetermined time and processes them as a set of data, thereby acquiring the eyeball information. By changing accumulation time for accumulating the event data, a plurality of pieces of the eyeball information with different generation speeds can be acquired.

The eyeball information includes line-of-sight position information related to a line-of-sight position (position where the user is viewing), saccade information related to a direction and a speed of saccade, and micro saccade information related to an occurrence frequency and an amplitude (change amount of the line-of-sight position) of the micro saccade. The eyeball information may include information related to an eyeball movement other than the saccade information and the micro saccade information, pupil information related to a size of a pupil and a change of a pupil diameter, blinking information related to a speed and the number of times of blinking and the like.

The eyeball information that can be acquired is not limited to the exemplified information. The event-data calculation portion 164 may execute image processing by mapping the event data for accumulation time as 1 frame of image data on the basis of an event generation coordinate (position coordinate of a pixel at which a luminance change (event) occurred). The event-data calculation portion 164 can acquire the eyeball information by the frame-based image processing from 1 frame of image data acquired by mapping the event data for the accumulation time.

A user-state determination portion 165 is a determination portion for determining a state of the user on the basis of the eyeball information acquired by the event-data calculation portion 164. The user-state determination portion 165 can acquire a visual-recognition range of the user from the eyeball information such as an occurrence frequency and an amplitude of the micro saccade and the like. The visual-recognition range is a range that the user is viewing, that is, a range to which the user's sight line is directed and has the same meaning as a caution range, an attention range. In addition, the user-state determination portion 165 can acquire user's line-of-sight direction from the line-of-sight position information, the eyeball information such as the saccade direction and the like.

The user-state determination portion 165 can determine a gaze degree or an overlooking degree as the user state from the occurrence frequency, the amplitude and the like of the micro saccade, for example. The gaze degree is such an index that, the narrower the visual-recognition range is, the higher the degree is and the wider the visual-recognition range is, the lower the degree is. The overlooking degree is, contrarily to the gaze degree, such an index that, the narrower the visual-recognition range is, the lower the degree is, while the wider the visual-recognition range is, the higher the degree is.

In addition, the user-state determination portion 165 can determine a concentration degree (degree on how concentrated) or a fatigue degree of the user from the occurrence frequency of the micro saccade, the amplitude of the micro saccade, a size of the pupil, a change amount of the pupil diameter, a speed of blinking, the number of times of blinking and the like. The fatigue degree is an index opposite to the concentration degree. In addition, the user-state determination portion 165 can determine a preference degree from the speed of the micro saccade, the change amount of the pupil diameter and the like. The preference degree is such an index that it gets higher when an object (preferred face or the like) that the user likes is viewed, while it gets lower when an object that the user does not prefer is viewed.

The information related to the state of the user such as the gaze range, the gaze degree (or the overlooking degree), the concentration degree (or the fatigue degree), the preference degree or the like will be described as the user-state information in the following. The user-state determination portion 165 can determine the user state by using a machine learning model such as a neural network with parameters related to the eyeball information and identification results of the object-identification portion 59 and the like as inputs and the user-state information as an output, for example. Note that the user-state determination portion 165 is not limited to the above, but information related to the user's state can be acquired by arbitrarily combining information included in the eyeball information.

The system control portion 50 can acquire information of a position and a size of a region of the object displayed on the EVF 29 (hereinafter described as an object range). In addition, the eyeball detection unit 161 can acquire information on a range to which the user's sight line is directed on the EVF 29. Therefore, the system control portion 50 can determine which region in the object the user is viewing.

The flash device 300 is an illumination device which irradiates the object to be a photographing target and includes a Xe (xenon) tube light-emitting device and an LED light and the like. The flash device 300 is capable of being detachably attached to the imaging device 100. The flash device 300 has a communication terminal 301, a light emission portion 303, a system control portion 302, a zoom drive portion 304, and a bounce drive portion 305.

The communication terminal 301 is a communication terminal that the flash device 300 performs communication with the imaging device 100. The flash device 300 communicates with the system control portion 50 via the communication terminal 301 and the communication terminal 180 and controls light emission of the light emission portion 303 by the system control portion 302. In addition, the system control portion 302 changes the irradiation range of the light emission portion 303 by controlling the zoom drive portion 304 and changes an irradiation direction of the light emission portion 303 by controlling the bounce drive portion 305.

Note that the flash device 300 is not limited to an illumination device which can be detachably attached to the imaging device 100 but may be an external illumination device which irradiates an object, which is a photographing target. The external illumination device is connected to the imaging device 100 capable of communication in a wired manner or wirelessly and can receive information used for controlling the irradiation range and the irradiation direction from the imaging device 100.

The external device 400 is an external device which can be detachably attached to the imaging device 100 and may be connected to the imaging device 100 by a connection cable. A communication terminal 401 is a communication terminal for the external device 400 to perform communication with the imaging device 100. The external device 400 communicates with the system control portion 50 through the communication terminal 401 and the communication terminal 181. An operation portion 403 of the external device 400 is a various-operation member as an input portion which receives an operation from the user. The operation portion 403 includes at least any one of a shutter button, a power switch, an electronic dial, a direction key, a video button, a reproducing button, and a menu reading-out button. A system control portion 402 of the external device 400 can communicate with the system control portion 50 and control the imaging device 100. In addition, the system control portion 402 can also control the system control portion 302 of the flash device 300 through the system control portion 50.

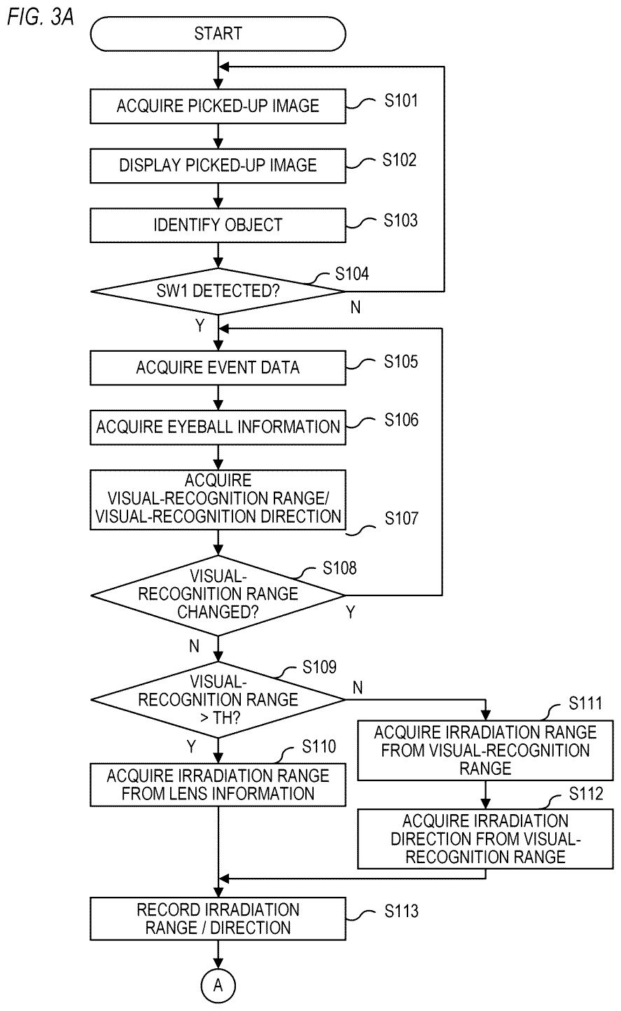

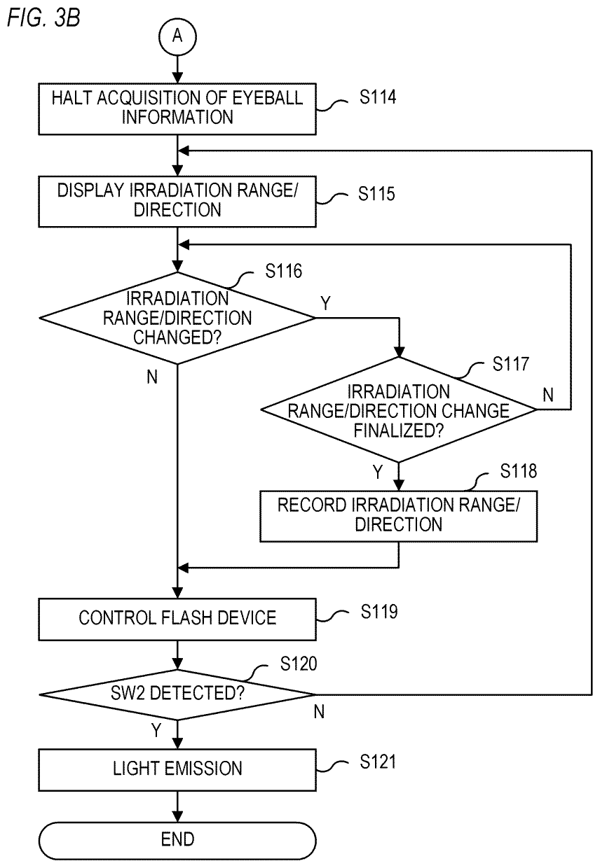

With reference to FIGS. 3A and 3B, FIGS. 4A to 4D, and FIGS. 5A and 5B, processing of controlling the irradiation range and the irradiation direction of the flash device 300 by estimating the visual-recognition range of the user by the imaging device 100 according to the Embodiment 1 will be explained.

FIGS. 3A and 3B are flowcharts for explaining irradiation processing according to the Embodiment 1. Each processing of the flowcharts in FIGS. 3A and 3B is realized by the system control portion 50 of the imaging device 100 expanding the program stored in the non-volatile memory 56 to the system memory 52 and executing it and by controlling each configuration (block). In addition, the processing shown in FIGS. 3A and 3B is started when the power switch 72 is turned on, and such a state is brought about that the user's eye 160 approaches the eyepiece portion 16 of the finder in the still-image photographing mode.

At Step S101, the system control portion 50 acquires a picked-up image (data of the picked-up image) picked up by the imaging portion 22 and stores it in a video memory region of the memory 32. At Step S102, the system control portion 50 reads out the picked-up mage from the video memory region of the memory 32 and displays it on the EVF 29.

At Step S103, the system control portion 50 transmits the picked-up image acquired at Step S101 to the object-identification portion 59. The object-identification portion 59 analyzes the received picked-up image, identifies (detects) the object, and acquires information of the object. The information of the object includes a type of the object, a size of the object on the picked-up image, a position of the object on the picked-up image and the like. The object-identification portion 59 identifies the type of the object and specifies the size and the position of the object on the picked-up image.

At Step S104, the system control portion 50 determines whether or not the first shutter-switch signal SW1 has been detected. The first shutter-switch signal SW1 is generated by the user half-pressing the shutter button 61 in order to instruct photographing. In the system control portion 50, when the shutter button 61 is operated by the user, and the first shutter-switch signal SW1 is detected, it is determined that the user has an intention of photographing. When the first shutter-switch signal SW1 is detected, the system control portion 50 proceeds to Step S105 and acquires the eyeball information. When the shutter button 61 is not operated by the user, and the first shutter-switch signal SW1 is not detected, the system control portion 50 determines that the user does not have an intention of photographing. When the first shutter-switch signal SW1 is not detected, the system control portion 50 returns to Step S101.

At Step S105, the system control portion 50 acquires event data by the event sensor 163. The system control portion 50 transmits the acquired event data to the event-data calculation portion 164.

At Step S106, the system control portion 50 analyzes the event data by the event-data calculation portion 164 and acquires the eyeball information, which is information on the eye of the user viewing the picked-up image. The system control portion 50 transmits the acquired eyeball information to the user-state determination portion 165 via the memory 32. The eyeball information includes at least any one of the line-of-sight position information, the saccade direction, the saccade speed, the occurrence frequency of micro saccade, the amplitude of the micro saccade, the size of the pupil, the change in the pupil diameter, the speed of blinking, and the number of times of blinking.

At Step S107, the system control portion 50 acquires the information on the user's visual-recognition range and visual-recognition direction by the user-state determination portion 165. The system control portion 50 stores the acquired information of the visual-recognition range and visual-recognition direction in the memory 32. The information on the line-of-sight direction may include a coordinate of a center point of the visual-recognition range, for example.

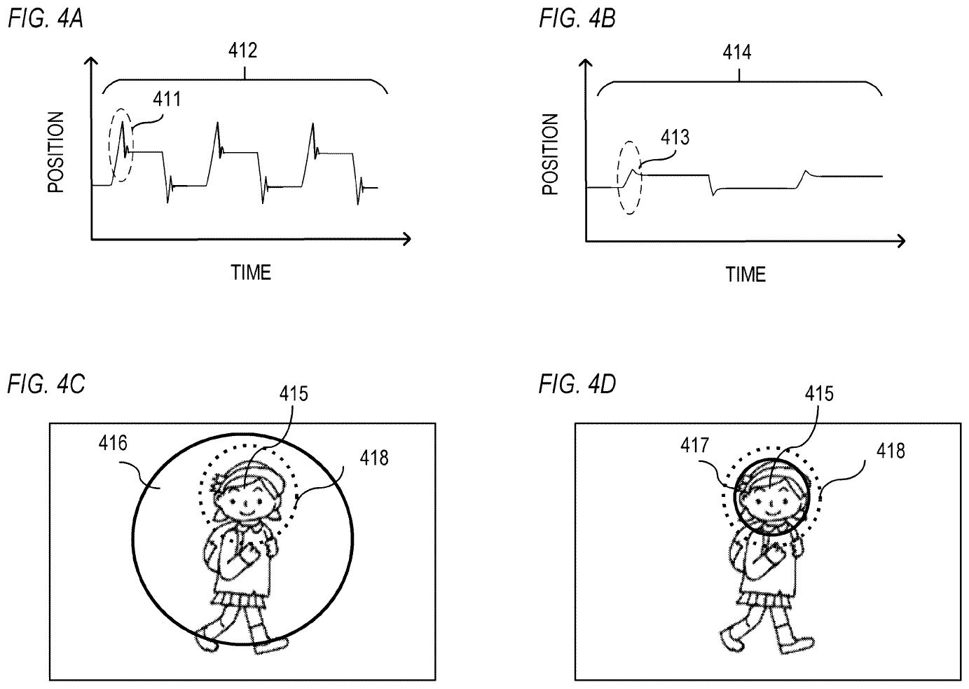

With reference to FIGS. 4A to 4D, a relation between the eyeball information and the visual-recognition range will be explained. FIGS. 4A and 4B are diagrams illustrating micro saccade information acquired by the event-data calculation portion 164 as eyeball information. A vertical axis is a position (position indicated by an angle) of the pupil center in a coordinate system with the eyeball center as an origin. A lateral axis is time.

FIG. 4A illustrates a micro-saccade waveform when the visual-recognition range is wider than the example in FIG. 4B. A graph of a part surrounded by a broken line 411 indicates a change in an eyeball position at occurrence of the micro saccade. There is such a tendency that the wider the visual recognition range is, the larger the amplitude of the eyeball movement (amplitude of the eyeball position) becomes, and oscillation becomes higher (attenuation rate lowers). In addition, an occurrence frequency of the micro saccade in a period 412 tends to be higher.

On the other hand, FIG. 4B illustrates a micro-saccade waveform when the visual-recognition range is narrower than the example in FIG. 4A. A graph of a part surrounded by a broken line 413 indicates a change in the eyeball position at occurrence of the micro saccade. There is such a tendency that the narrower the visual-recognition range is, the smaller the amplitude of the eyeball movement becomes, and the oscillation becomes lower (attenuation rate rises). In addition, the occurrence frequency of the micro saccade in a period 414 with the same length as that of the period 412 tends to be lower.

The user-state determination portion 165 can estimate a visual-recognition range of the user on the picked-up image by using a machine learning model such as a neural network with the amplitude and oscillation, which are feature amounts of the eyeball movement, as input parameters and the visual-recognition range as an output.

At Step S108, the system control portion 50 determines whether or not the visual-recognition range of the user has changed in a predetermined period of time. If the visual-recognition range has not changed in the predetermined period of time, processing proceeds to Step S109. If there was a change in the visual-recognition range in the predetermined period of time, the processing returns to Step S105, and the system control portion 50 acquires the eyeball information again. Note that, even if the visual-recognition range has not changed within the predetermined period of time, the system control portion 50 can determine whether the visual-recognition range has changed or not by continuously executing the processing at Steps S105 to S108.

At Step S109, the system control portion 50 determines whether or not the visual-recognition range acquired at Step S107 is wider than a predetermined range. The system control portion 50 determines whether or not the size of the visual-recognition range is larger than a threshold value TH determined in advance, for example. The threshold value TH may be a value determined in advance or may be determined on the basis of information of the object acquired at Step S103. The threshold value TH may be such a size of the object range, which is a region including the object detected from the picked-up image, for example.

When the size of the visual-recognition range is larger than the threshold value TH, the system control portion 50 determines that the user is overlooking the entire field angle. When the size of the visual-recognition range is larger than the threshold value TH, the system control portion 50 proceeds to Step S110 in order to acquire an irradiation range on the basis of lens information. When the size of the visual-recognition range is smaller than the threshold value TH, the system control portion 50 determines that the user is visually recognizing a specific object. When the size of the visual-recognition range is smaller than the threshold value TH, the system control portion 50 proceeds to Step S111 in order to acquire the irradiation range on the basis of the visual-recognition range. When the size of the visual-recognition range is equal to the threshold value TH, the system control portion 50 may proceed to Step S110 or Step S111.

At Step S110, the system control portion 50 acquires the lens information of the lens unit 150. The lens information includes information on zoom of the lens 103, for example. The system control portion 50 acquires an irradiation range of the flash device 300 on the basis of the lens information. Note that the irradiation direction of the flash device 300 can be a direction set in advance.

At Step S111, the system control portion 50 acquires the irradiation range of the flash device 300 on the basis of the visual-recognition range acquired at Step S107. At Step S112, the system control portion 50 acquires the irradiation direction of the flash device 300 on the basis of the line-of-sight direction acquired at Step S107.

With reference to FIGS. 4C and 4D, an example of a determination method of the irradiation range and the irradiation direction explained at Step S109 to Step S112 will be explained. FIGS. 4C and 4D correspond to the micro-saccade waveforms of FIGS. 4A and 4B, respectively, and are diagrams exemplifying a visual recognition state of the user on the EVF 29. The object 415 is an object, that is a photographing target.

A object range 418 is an object range identified by the object-identification portion 59 at Step S103. In FIGS. 4C and 4D, the object-identification portion 59 identifies the head part of a character as the object range 418.

FIG. 4C illustrates an example determined that a visual-recognition range 416 of the user is wider than the object range 418, and the size of the visual-recognition range 416 is larger than the threshold value TH at Step S109. FIG. 4D illustrates an example determined that a visual-recognition range 417 of the user is narrower than the object range 418, and the size of the visual-recognition range 417 is smaller than the threshold value TH at Step S109. The visual-recognition range 416 and the visual-recognition range 417 are visual-recognition ranges acquired by the user-state determination portion 165 at Step S107.

As shown in FIG. 4C, when the visual-recognition range 416 of the user is wider than the object range 418, it is estimated that the user is in such a state of overlooking the object 415 and the background. In order to perform photographing intended by the user, it is desirable that the flash device 300 irradiates the entire photographing field angle. In this case, at Step S110, the irradiation range of the flash device 300 is set on the basis of the lens information acquired from the lens unit 150. Note that the irradiation direction (angle) of the flash device 300 is a direction set in advance and may be an optical axis direction, for example. In addition, the irradiation direction may be a direction of the object identified by the object-identification portion 59.

When the user's visual-recognition range 417 is narrower than the object range 418 as shown in FIG. 4D, it is estimated that the user is in a state of viewing the object 415 with attention. In order to perform photographing intended by the user, it is desirable that the flash device 300 irradiates the object range 418. In this case, at Steps S111, S112, the irradiation range and the irradiation direction (angle) of the flash device 300 are set on the basis of the visual-recognition range 417.

At Step S113, the system control portion 50 records the information on the irradiation range and the irradiation direction of the flash device 300 acquired at Step S110 or Steps S111, S112 in the system memory 52.

At Step S114 in FIG. 3B, the system control portion 50 stops acquisition processing of the eyeball information at Steps S105 to S108. When the system control portion 50 determines that the user's visual-recognition range has not changed at Step S108, too, the system control portion 50 continuously executes the acquisition processing of the eyeball information, but while the information related to the irradiation range and the irradiation direction is displayed, the acquisition processing of the eyeball information is stopped.

At Step S115, the system control portion 50 displays the information related to the irradiation range and the irradiation direction of the flash device 300 recorded at Step S113 on at least either one of the display portion 28 and the EVF 29 by superposing it on the picked-up image. The user can confirm whether the displayed irradiation range and irradiation direction of the flash device 300 are the irradiation range and irradiation direction as intended.

At Step S116, the system control portion 50 determines whether or not the irradiation range or the irradiation direction has been changed by the user. The system control portion 50 receives a change operation instructing a change of the irradiation range and the irradiation direction of the flash device 300 through the operation portion 70. The change operation may be an operation of instructing a change of at least either one of the irradiation range and the irradiation direction.

When the user has not changed the irradiation range or the irradiation direction, the system control portion 50 determines that the irradiation range and the irradiation direction displayed at Step S115 is the irradiation range and the irradiation direction intended by the user. When the user has not changed the irradiation range or the irradiation direction, the processing proceeds to Step S119. When the user changed the irradiation range or the irradiation direction, the system control portion 50 determines that the irradiation range and the irradiation direction displayed at Step S115 are different from the irradiation range and the irradiation direction intended by the user. When the user changed the irradiation range or the irradiation direction, the processing proceeds to Step S117.

At Step S117, the system control portion 50 determines whether or not the irradiation range and the irradiation direction have been changed and finalized by the user. When the change of the irradiation range and the irradiation direction is finalized, the processing proceeds to Step S118. When the change of the irradiation range and the irradiation direction is not finalized, the processing returns to Step S116.

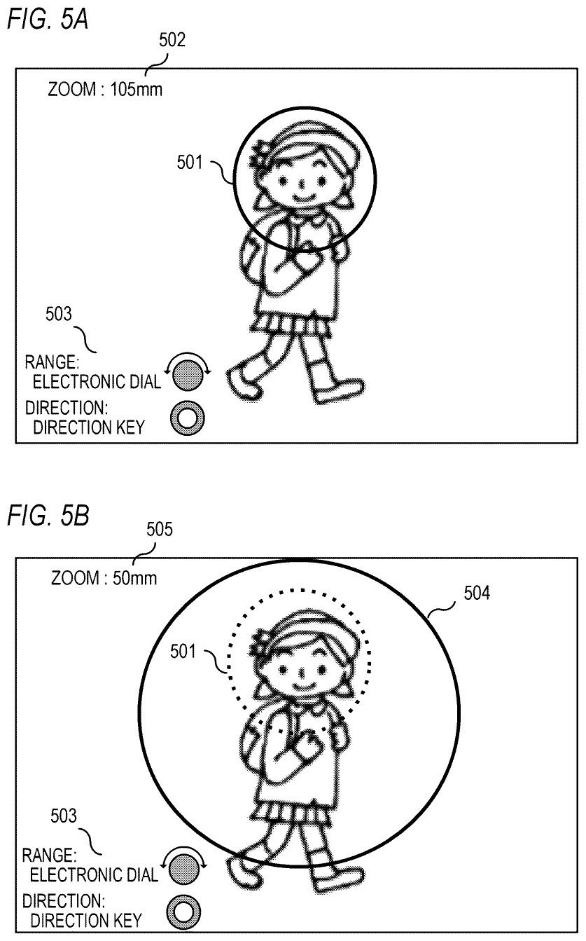

With reference to FIGS. 5A and 5B, a change (adjustment) of the irradiation range and the irradiation direction at Step S117 will be explained. FIG. 5A illustrates an example in which an irradiation range 501 is displayed on the EVF 29 at Step S115. FIG. 5B illustrates an example in which an irradiation range 504 is displayed after the user performs the operation of changing the irradiation range by the operation portion 70 at Step S117.

The irradiation range 501 of FIG. 5A is an irradiation range recorded in the system memory 52 at Step S113 and displayed by being superposed on the picked-up image displayed on the EVF 29. A display method of the irradiation range is not limited to a form of surrounding with a line but may be such a form that information of the zoom corresponding to the irradiation range, for example, is displayed as irradiation range information 502 by a numerical value. Moreover, in addition to the irradiation range information 502, the information of an irradiation angle indicating the irradiation direction may be displayed by a numerical value or the like. Note that only either one of the irradiation range 501 and the irradiation range information 502 may be displayed, or as shown in FIG. 5A, the both may be displayed.

Operation member information 503 indicates information of the operation member that the user can change the irradiation range and the irradiation direction at Step S117. In the example in FIGS. 5A and 5B, the operation member for changing the irradiation range is the main electronic dial 71, and the operation member for changing the irradiation direction is the direction key 74. For the operation members for changing the irradiation range and the irradiation direction, other operation members in the operation portion 70 of the imaging device 100 may be assigned.

The irradiation range 504 in FIG. 5B is an irradiation range after being changed by the operation member indicated in the operation member information 503. As the irradiation range 504, information of the zoom corresponding to the irradiation range may be displayed by a numerical value as irradiation range information 505 similarly to the irradiation range information 502 in FIG. 5A.

Note that the irradiation range and the irradiation direction are not limited to a case displayed on the EVF 29 but they may be displayed on the display portion 28. In addition, the change operation by the user for changing the irradiation range and the irradiation direction is not limited to the operation portion 70 but may be received through the operation portion 403 of the external device 400 which can be connected to the imaging device 100.

At Step S118, the system control portion 50 records the information on the irradiation range and the irradiation direction of the flash device 300 changed at Step S117 in the system memory 52. At Step S119, the system control portion 50 instructs the system control portion 302 of the flash device 300 to control the zoom drive portion 304 and the bounce drive portion 305 on the basis of the irradiation range and the irradiation direction recorded in the system memory 52. The system control portion 302 controls the zoom drive portion 304 and the bounce drive portion 305 in accordance with the instruction from the system control portion 50.

At Step S120, the system control portion 50 determines whether or not the second shutter-switch signal SW2 has been detected. The second shutter-switch signal SW2 is generated by full-pressing on the shutter button 61 by the user for instructing photographing. When the shutter button 61 is operated by the user, and the second shutter-switch signal SW2 is detected by the system control portion 50, the processing proceeds to Step S121 in order to start irradiation. When the shutter button 61 is not operated by the user, and the system control portion 50 does not detect the second shutter-switch signal SW2, the system control portion 50 returns to Step S115 in order to accept the change of the irradiation range again.

At Step S121, the system control portion 302 of the flash device 300 performs light emission by the light emission portion 303. When the light emission portion 303 starts irradiation, the imaging device 100 starts reading of the signal from the imaging portion 22.

According to the above-described Embodiment 1, the imaging device 100 can perform photographing by irradiation with the irradiation range and the irradiation direction intended by the user by controlling at least either one of the irradiation range and the irradiation direction of the flash device 300 on the basis of the visual recognition range of the user.

### Embodiment 2

In the Embodiment 2, a flash device (illumination device) of an electronic device according to the present invention has a plurality of light emission portions with irradiation possible ranges different from one another. The electronic device determines a light emission portion to be a control target in the plurality of light emission portions on the basis of the user's visual-recognition range and the respective irradiation possible ranges of the plurality of light emission portions. The electronic device controls at least either one of the irradiation range and the irradiation direction by the flash device by controlling the light emission portion determined to be a control target.

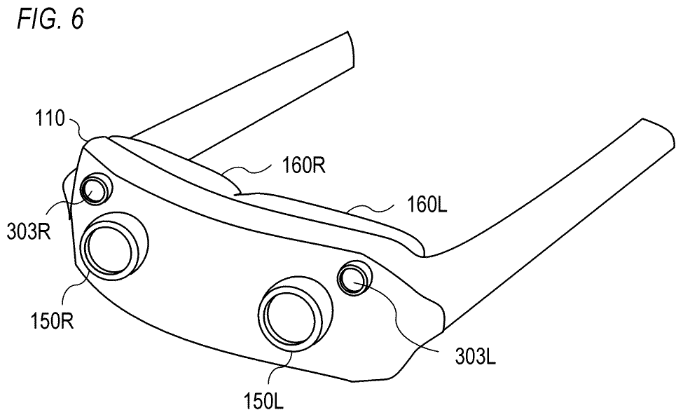

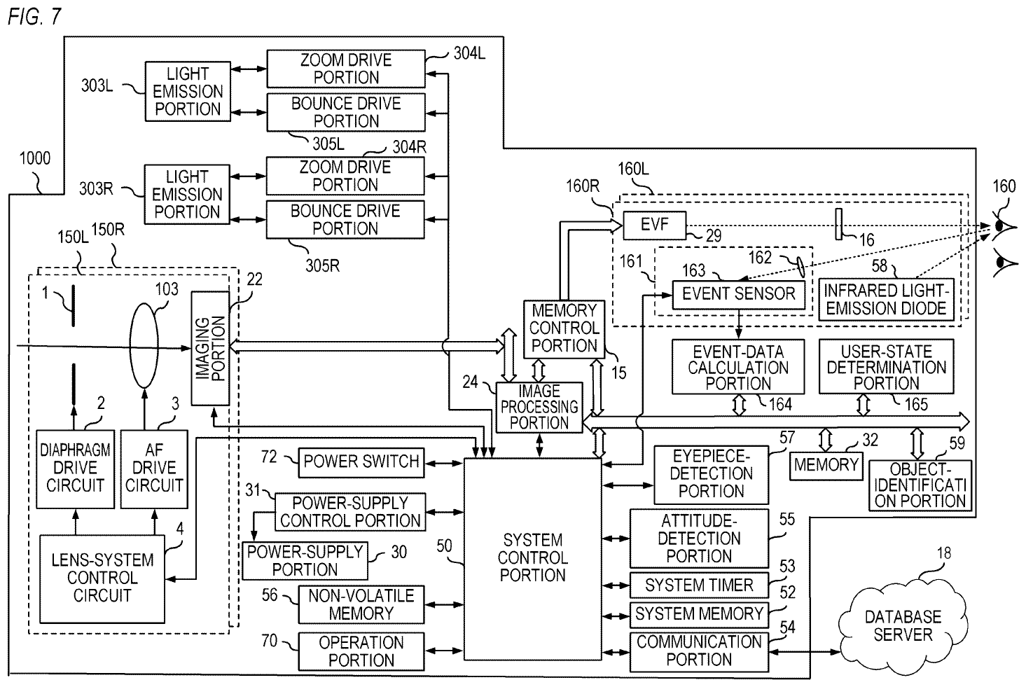

FIG. 6 is an appearance view of a wearable device 1000 as an example of the electronic device to which the present invention can be applied. FIG. 7 is a block diagram illustrating a configuration example of the wearable device 1000. In the wearable device 1000 according to the Embodiment 2, the same signs are given to the same configurations (including the operation member) of the imaging device 100 according to the Embodiment 1, and the explanation will be omitted. Hereinafter, configurations different from the Embodiment 1 will be explained.

In FIG. 6, an image pickup unit 150R for right eye and an image pickup unit 150L for left eye include the lens 103 and the imaging portion 22, respectively. The image pickup unit 150R for right eye and the image pickup unit 150L for left eye have zoom mechanisms mounted, respectively, and the user can change a zoom rate of the image pickup unit 150R for right eye and the image pickup unit 150L for left eye by using the operation portion 70. The wearable device 110 can execute optical zoom for controlling a lens position by the zoom mechanism, electronic zoom by cutting out and enlarging a part of the picked-up image, or zoom processing combining the optical zoom and the electronic zoom as zoom operations.

A display unit 160R for right eye and a display unit 160L for left eye include the eyepiece portion 16, the EVF 29, and the eyeball detection unit 161, respectively. The user visually recognizes an image (image for right eye) displayed on the display unit 160R for right eye with the right eye and visually recognizes an image (image for left eye) displayed on the display unit 160L for left eye with the left eye in a state where the wearable device 110 is worn. For example, on the display unit 160R for right eye, an image picked up by the image pickup unit 150R for right eye is displayed, while on the display unit 160L for left eye, an image picked up by the image pickup unit 150L for left eye is displayed.

In FIG. 7, the operation portion 70 is a various-operation member as an input portion that accepts an operation from the user (user operation). The operation portion 70 includes a sound UI and a touch pad, for example. The touch pad is mounted on a side surface (not shown) of the wearable device 1000. The system control portion 50 can detect an operation to the touch pad or a state of the touch pad. A coordinate of a position where the finger touches on the touch pad is notified to the system control portion 50 via an internal bus, and the system control portion 50 determines what operation (touch operation) was made on the touch pad on the basis of the notified information. As the touch pad, any one of touch panels in various types such as a resistive membrane type, an electrostatic capacitance type, a surface acoustic wave type, an infrared ray type, an electromagnetic induction type, an image recognition type, an optical sensor type and the like.

The power switch 72 is an operation member for switching on and off of the power supply of the wearable device 1000. The communication portion 54 performs transmission/reception of a video signal and a sound signal with external equipment connected wirelessly or by a wired cable. The communication portion 54 can perform transmission/reception of data with an external database server 18.

The attitude-detection portion 55 detects an attitude of the wearable device 1000 with respect to the gravity direction. As the attitude-detection portion 55, an acceleration sensor, a gyro sensor or the like can be used. By means of the attitude-detection portion 55, movement of the wearable device 1000 (panning, tilting, rolling, still or not and the like) can be detected.

The eyepiece-detection portion 57 is a wearing-detection sensor for detecting whether or not the user wears the wearable device 1000. The system control portion 50 can switch start (power-on)/stop (power-off) of the wearable device 1000 in accordance with a state detected by the eyepiece-detection portion 57.

The flash device of the wearable device 1000 includes a light emission portion 303R, a light emission portion 303L, a zoom drive portion 304R, a zoom drive portion 304L, a bounce drive portion 305R, and a bounce drive portion 305L. The light emission portion 303R and the light emission portion 303L are LED lights, for example.

The system control portion 50 can control the irradiation ranges of the light emission portion 303R and the light emission portion 303L, respectively, by controlling the zoom drive portion 304R and the zoom drive portion 304L. In addition, the system control portion 50 can control the irradiation directions of the light emission portion 303R and the light emission portion 303L, respectively, by controlling the bounce drive portion 305R and the bounce drive portion 305L.

The zoom drive portion 304R is capable of adjustment of the zoom position on the tele side (tele side) and is capable of light-emission control with a narrower irradiation range and a higher light-emission intensity than those of the zoom drive portion 304L. The zoom drive portion 304L is capable of adjustment of the zoom position on the wide side (wide side) and is capable of light-emission control with a wider irradiation range and a lower light-emission intensity than those of the zoom drive portion 304R.

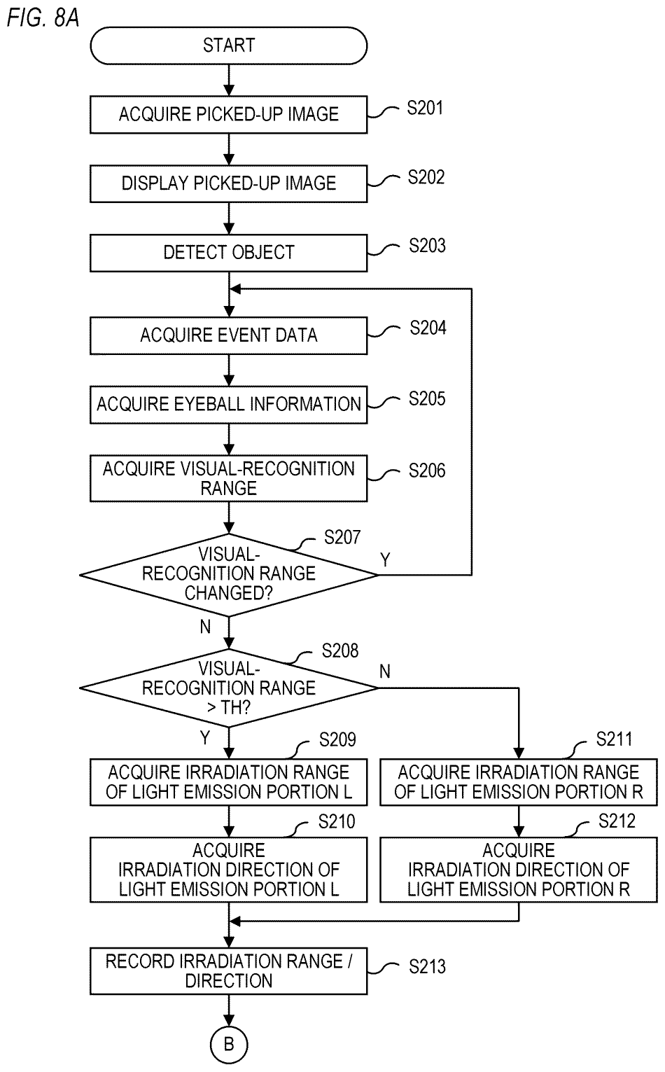

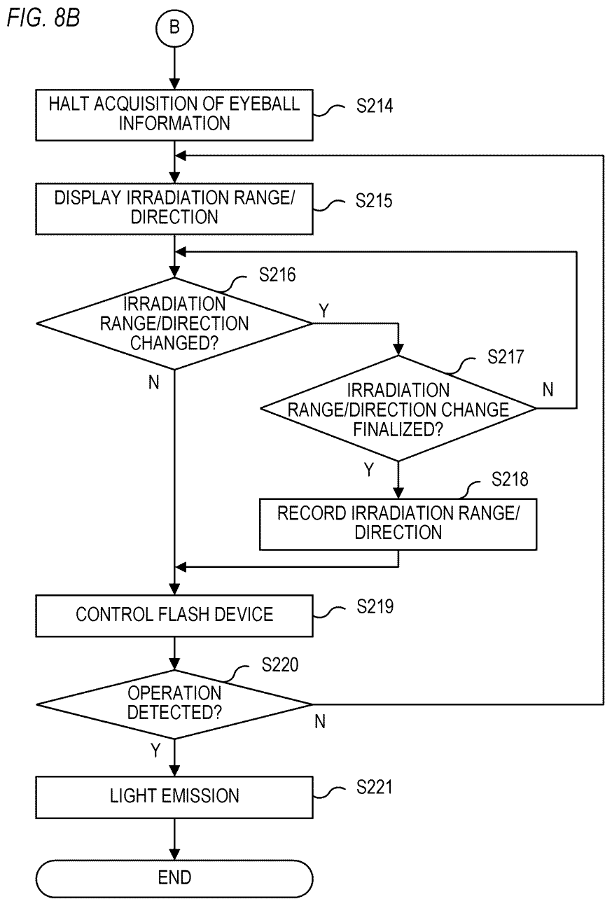

With reference to FIGS. 8A and 8B, processing of controlling the irradiation range and the irradiation direction the flash device (the light emission portion 303R, the light emission portion 303L) by estimating the line-of-sight range of the user by the wearable device 1000 according to the Embodiment 2 will be explained.

FIGS. 8A and 8B are flowcharts for explaining irradiation processing according to the Embodiment 2. Each processing of the flowcharts in FIGS. 8A and 8B is realized by the system control portion 50 of the wearable device 1000 expanding the program stored in the non-volatile memory 56 to the system memory 52 and executing it so as to control each configuration (block). In addition, the processing shown in FIGS. 8A and 8B is started when the user wears the wearable device 1000, and the power switch 72 is turned on.

Since the processing at steps S201 to S203 and the processing at Steps S204 to S207 are the same as the processing at Steps S101 to S103 and the processing at Steps S105 to S108 in FIG. 3A, respectively, explanation will be omitted.

At Step S208, the system control portion 50 determines whether or not the visual-recognition range acquired at Step S206 is wider than a predetermined range. The system control portion 50 determines whether or not the size of the visual-recognition range is larger than the threshold value TH set in advance, for example.

The threshold value TH, for example, is determined on the basis of a maximum value (max value) of an irradiation range at a zoom position which can be set by the zoom drive portion 304R or a minimum value (min value) of the irradiation range at a zoom position which can be set by the zoom drive portion 304L. In a case where a settable range of the zoom position of the zoom drive portion 304R is 80 to 200 mm, and a settable range of the zoom position of the zoom drive portion 304L is 14 to 80 mm, for example, the threshold value TH is set at a value based on the zoom position 80 mm (size of the irradiation range).

When the size of the visual-recognition range is larger than the threshold value TH, that is, when the visual-recognition range is within an irradiation range at the zoom position of the zoom drive portion 304L, the processing proceeds to Step S209. When the size of the visual-recognition range is smaller than the threshold value TH, that is, when the visual-recognition range is within the irradiation range at the zoom position of the zoom drive portion 304R, the processing proceeds to Step S211. When the size of the visual-recognition range is equal to the threshold value TH, the system control portion 50 may proceed to either one of Step S209 and Step S211.

At Step S209, the system control portion 50 acquires the irradiation range of the light emission portion 303L on the basis of the visual-recognition range acquired at Step S206. At Step S210, the system control portion 50 acquires the irradiation direction of the light emission portion 303L on the basis of the visual-recognition range acquired at Step S206.

At Step S211, the system control portion 50 acquires the irradiation range of the light emission portion 303R on the basis of the visual-recognition range acquired at Step S206. At Step S212, the system control portion 50 acquires the irradiation direction of the light emission portion 303R on the basis of the visual-recognition range acquired at Step S206.

At Step S213, the system control portion 50 records the information on the irradiation range and the irradiation direction of the light emission portion 303L or the information on the irradiation range and the irradiation direction of the light emission portion 303R acquired at Steps S209 to S212 in the system memory 52.

At Step S214 in FIG. 8B, the system control portion 50 stops acquisition processing of the eyeball information at Steps S204 to S207. The system control portion 50 continuously executes the acquisition processing of the eyeball information even when it is determined that the user's visual-recognition range has not been changed at Step S207 but it stops the acquisition processing of the eyeball information while the information related to the irradiation range and the irradiation direction is displayed.

At Step S215, the system control portion 50 displays the information related to the irradiation range and the irradiation direction of the light emission portion 303R or the light emission portion 303L recorded at Step S213 on the EVF 29 by superposing it on the picked-up image.

At Step S216, the system control portion 50 determines whether or not the irradiation range or the irradiation direction has been changed by the user. The system control portion 50 accepts a change operation instructing a change of the irradiation range and the irradiation direction of the flash device 300 via the operation portion 70. The change operation may be an operation to instruct a change of at least either one of the irradiation range and the irradiation direction.

When the user has not changed the irradiation range or the irradiation direction, the system control portion 50 determines that the irradiation range and the irradiation direction displayed at Step S215 are the irradiation range and the irradiation direction intended by the user. When the user has not changed the irradiation range or the irradiation direction, the processing proceeds to Step S219. When the user changed the irradiation range or the irradiation direction, the system control portion 50 determines that the irradiation range and the irradiation direction displayed at Step S115 are different from the irradiation range and the irradiation direction intended by the user. When the user changed the irradiation range or the irradiation direction, the processing proceeds to Step S217.

At Step S217, the system control portion 50 determines whether or not the irradiation range and the irradiation direction have been changed and finalized by the user. When the change of the irradiation range and the irradiation direction is finalized, the processing proceeds to Step S218. When the change of the irradiation range and the irradiation direction is not finalized, the processing returns to Step S216.

At Step S218, the system control portion 50 records the irradiation range or the irradiation direction of the light emission portion 303R or the light emission portion 303L changed at Step S217 in the system memory 52.

At Step S219, the system control portion 50 controls the zoom drive portion 304R or the zoom drive portion 304L and the bounce drive portion 305R or the bounce drive portion 305L on the basis of the irradiation range and the irradiation direction recorded in the system memory 52.

Note that, at Step S219, the system control portion 50 controls the zoom drive portion 304 and the bounce drive portion 305 of the light emission portion 303 corresponding to the irradiation range and the irradiation direction after being changed by the user. For example, when the information on the irradiation range and the irradiation direction corresponding to the light emission portion 303R is displayed on the EVF 29 and changed to the irradiation range and the irradiation direction corresponding to the light emission portion 303L, the system control portion 50 controls the zoom drive portion 304L and the bounce drive portion 305L. On the contrary, when the irradiation range and the irradiation direction of the light emission portion 303L are displayed on the EVF 29 and changed to the irradiation range and the irradiation direction corresponding to the light emission portion 303R, the system control portion 50 controls the zoom drive portion 304R and the bounce drive portion 305R.

At Step S220, the system control portion 50 determines whether or not an operation of a light emission instruction has been detected. The system control portion 50 can determine that the operation of the light emission instruction was detected, when the operation to the operation member to which the operation of the light emission instruction was assigned is detected. When the operation of the light emission instruction is detected, the system control portion 50 proceeds to Step S221 in order to start irradiation. When the operation of the light emission instruction is not detected, the system control portion 50 returns to Step S215 in order to accept a change of the irradiation range again.

At Step S221, the system control portion 50 performs light emission by the light emission portion 303R or the light emission portion 303L on the basis of the control at Step S219.

Note that the explanation was made such that the light emission portion 303R is a light emission portion for the tele side and the light emission portion 303L is a light emission portion for the wide side, but the light emission portion 303R may be assigned to the wide side, and the light emission portion 303L to the tele side.

In addition, the number of the light emission portions 303 of the flash device is not limited to two, but three or more light emission portions 303 with irradiation possible ranges different from one another may be provided. The flash device has the zoom drive portion 304 and the bounce drive portion 305 corresponding to the respective light emission portions 303. The system control portion 50 determines the light emission portion to be a control target on the basis of the user's visual-recognition range and the irradiation possible range of each of the light emission portions 303. The system control portion 50 can control the irradiation range and the irradiation direction by the flash device by controlling the zoom drive portion 304 and the bounce drive portion 305 corresponding to the determined light emission portion 303.

According to the above-described Embodiment 2, in the wearable device 1000, an irradiation range wider than the configuration with one light emission portion can be set by mounting a plurality of the light emission portions with irradiation possible ranges different from one another. In addition, by selecting the light emission portion suitable for the user's visual-recognition range from the plurality of light emission portions, responsiveness to a change in the line-of-sight position and the visual recognition range can be improved, when the zoom drive and the bounce drive are to be controlled in a wider range from a wide end to a tele end.

Note that in the Embodiment 1 and the Embodiment 2, the electronic device (the imaging device 100 and the wearable device 1000) estimates the visual-recognition range by using the event sensor 163. The event-based sensor can acquire data with lower power and lower latency as compared with a frame-based sensor. However, the present invention is not limited to such a configuration that the visual-recognition range is estimated by using the event-based sensor. As long as it is within a range where power consumption and a data transfer amount are allowed, the electronic device may use a frame-based sensor with a high frame rate.

In addition, the visual-recognition range may be estimated by simultaneously using the event-based sensor and the frame-based sensor. For example, the electronic device may adopt a visual-recognition range estimated by combining the visual-recognition range estimated by using the event-based sensor and the visual-recognition range estimated by using the frame-based sensor or any one of the visual-recognition ranges in accordance with a predetermined condition. The predetermined condition may be conditions such as a change in a moving speed or a positional attitude of the user wearing the wearable device 1000, for example.

In addition, in the Embodiment 1 and the Embodiment 2, the electronic device estimates a visual-recognition range by using the micro saccade movement. The electronic device can estimate the visual-recognition range at a relatively high speed by using the micro saccade movement. Note that the use of the micro saccade movement is not limiting, but the electronic device may record a change in the line-of-sight position as history information and estimate the visual-recognition range from the change in the line-of-sight position in a predetermined time.

As a preferred embodiment of the present invention, the imaging device 100 and the wearable device 1000 have been described in detail, but the present invention is not limited to these specific embodiments. Configurations obtained by deforming or changing the configuration of the above-described embodiments as appropriate within a range of the scope of the present invention are also included in the present invention. Configurations obtained by combining the configurations of the above-described embodiments as appropriate are also included in the present invention.

The present invention can be applied to various devices if they are electronic devices having the configuration explained in each of the Embodiments. For example, the electronic device according to the present invention may be a digital microscope, a display device such as an image viewer with a camera, a personal computer, a PDA (Personal Digital Assistant), a mobile phone terminal, a game machine and the like. The electronic device can irradiate a range intended by the user with the flash device (illumination device) on the basis of the eyeball information including the user's line-of-sight position.

According to the present invention, the irradiation range intended by the user can be efficiently irradiated and photographed.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-011967. filed on Jan. 30, 2024, which is hereby incorporated by reference herein in its entirety.

What is claimed is:

1. An electronic device comprising:
a processor; and
a memory storing a program which, when executed by the processor, causes the electronic device to:
perform estimating processing to estimate, based on eyeball information, which is information related to an eye of a user viewing a picked-up image, a visual-recognition range of the user in the picked-up image;
perform acquiring processing to acquire a region including an object from the picked-up image; and
perform control processing to perform control such that at least either one of an irradiation range and an irradiation direction of an illuminating unit configured to illuminate a photographing target is set based on the visual-recognition range estimated in the estimating processing and the region including the object acquired in the acquiring processing.

2. The electronic device according to claim 1, wherein
the eyeball information includes at least any one of line-of-sight position information, a direction of saccade, a speed of the saccade, an occurrence frequency of micro saccade, an amplitude of the micro saccade, a size of a pupil, a change in a pupil diameter, a speed of blinking, and a number of times of blinking.

3. The electronic device according to claim 1, wherein
in a case where the user instructs photographing, the eyeball information is acquired in the estimating processing.

4. The electronic device according to claim 1, wherein
in the control processing,
control is performed such that at least either one of the irradiation range and the irradiation direction of the illuminating unit is set based on the region including the object, in a case where the visual-recognition range is narrower than the region including the object; and
control is performed such that at least either one of the irradiation range and the irradiation direction of the illuminating unit is set based on information of a zoom of a lens that picks up the picked-up image, in a case where the visual-recognition range is wider than the region including the object.

5. The electronic device according to claim 1, wherein
in the control processing, control is performed such that an entire field of angle of the picked-up image is set to the irradiation range of the illuminating unit, in case where the visual-recognition range is wider than a predetermined range.

6. The electronic device according to claim 1, wherein
in the control processing, information related to the irradiation range and the irradiation direction of the illuminating unit is displayed on a display portion by superposing the information on the picked-up image.

7. The electronic device according to claim 1, further comprising an electronic view finder, wherein
in the control processing, information related to the irradiation range and the irradiation direction of the illuminating unit is displayed on the electronic view finder by superposing the information on the picked-up image.

8. The electronic device according to claim 6, wherein
in the estimating processing, acquisition of the eyeball information is stopped while information related to the irradiation range and the irradiation direction is displayed.

9. The electronic device according to claim 1, wherein
in the control processing, a change operation for instructing a change in the irradiation range and the irradiation direction of the illuminating unit is accepted.

10. The electronic device according to claim 9, wherein
in the control processing, the change operation is accepted through an operation portion of an external device.

11. The electronic device according to claim 9, wherein
in the control processing, at least either one of the irradiation range and the irradiation direction of the illuminating unit is controlled based on the change operation.

12. The electronic device according to claim 1, wherein
the illuminating unit has:
a light emission portion;
a zoom drive portion that controls the irradiation range by the light emission portion; and
a bounce drive portion that controls the irradiation direction by the light emission portion.

13. The electronic device according to claim 12, wherein
in the control processing, the irradiation range is controlled by controlling the zoom drive portion and the irradiation direction is controlled by controlling the bounce drive portion.

14. The electronic device according to claim 1, wherein
the illuminating unit has a plurality of light emission portions having irradiation possible ranges different from one another;
in the control processing, at least either one of the irradiation range and the irradiation direction of the illuminating unit is controlled by controlling any one of the plurality of light emission portions based on the visual-recognition range and the irradiation possible range of each of the plurality of light emission portions.

15. The electronic device according to claim 2, wherein
the eyeball information further includes information related to a change in an eyeball position of the user.

16. The electronic device according to claim 15, wherein
in the estimating processing the visual-recognition range of the user in the picked-up image is estimated based on intensity of a change in the eyeball position.

17. A control method of an electronic device, the control method comprising:
an estimating step of estimating, based on eyeball information, which is information related to an eye of a user viewing a picked-up image, a visual-recognition range of the user in the picked-up image;
an acquisition step of acquiring a region including an object from the picked-up image; and
a control step of controlling such that at least either one of an irradiation range and an irradiation direction of an illuminating unit that illuminates a photographing target is set based on the visual-recognition range estimated in the estimating step and the region including the object acquired in the acquisition step.

18. A non-transitory computer readable medium storing a program that causes a computer to execute a control method of an electronic device comprising:
an estimating step of estimating, based on eyeball information, which is information related to an eye of a user viewing a picked-up image, a visual-recognition range of the user in the picked-up image;
an acquisition step of acquiring a region including an object from the picked-up image; and
a control step of controlling such that at least either one of an irradiation range and an irradiation direction of an illuminating unit that illuminates a photographing target is set based on the visual-recognition range estimated in the estimating step and the region including the object acquired in the acquisition step.
